(19) United States
(12) Patent Application Publication
(10) Pub. No.: US 2010/0332153 A1
(43) Pub. Date: Dec. 30, 2010

(54) Method of Determining Fatigue Life and Remaining Life

(76) Inventors: Reinder Hindrik Vegter, Culemborg (NL); Jan Ture Slycke, Bilthoven (NL)

Correspondence Address: SKF USA Inc., 890 Forty Foot Road, PO Box 352, Lansdale, PA, 19446, US

(21) Appl. No.: 12/808,154

(22) PCT Filed: Dec. 14, 2007
(86) PCT No.: PCT/EP2007/010995

§ 371 Date: Sep. 8, 2010

(51) Int. Cl. G01N 3/24

(52) U.S. Cl. 702/42

(57) ABSTRACT

The present invention concerns a method of calculating the expected life of a hardened metal object in relation to a number of fatigue load cycles exerted on the hardened metal object. The method comprises determining the development of microstructural deterioration as a function of fatigue exposure time, deriving therefrom an equation for the development of a Fatigue Damage Index as a function of fatigue exposure time and relating this equation to a known critical value of the Fatigue Damage Index that leads to material failure. The present invention also provides a method of calculating the remaining life of a hardened metal object subjected to fatigue loading.

### TECHNICAL FIELD

The invention concerns a method of determining the expected life and/or the remaining life of a hardened metal object, particularly a rolling element bearing, which is subjected to fatigue loading.

### BACKGROUND

Fatigue, one of the most common material degradation mechanisms in industry in general and in the bearing industry in particular, occurs when material experiences lengthy periods under repeated or cyclic stresses which can lead to failure at stress levels much lower than the tensile or yield strength. It has long been recognised that nearly 90% of industrial component failure takes place due to fatigue. To optimise the design and safety of machinery, it is therefore important to have an accurate prediction of the life and/or the remaining life of mechanical components such as bearings.

In current bearing life models, the failure of bearings is calculated using a mathematical framework that has been developed over the past decades. A first model predicted the L10 life of a bearing, which is the operating time or number of load cycles after which 10% of a tested population of bearings has failed. The calculation is based on dynamic load, equivalent bearing load and a factor dependent on the geometry of the rolling contact.

A refined model was later proposed, which not only includes a load-based calculation, but also introduces a modification factor to take account of lubrication and its potential life-limiting effect through decreased film thickness and to take account of the level of contamination in the bearing. Once again, the data from life tests provided the experimental basis for calibrating the modification factor and the refined life calculation.

Another example in this direction is disclosed in EP1184813A2, which describes how a dynamic equivalent load P is calculated from data information of a rolling bearing. Thereafter, a reliability coefficient a_{I} is determined, a lubrication parameter a_{L} corresponding to a used lubricant is calculated, and a contamination degree coefficient a_{c} is determined in consideration of a material coefficient. A fatigue limit load Pᵤ is calculated on the basis of the data information. Thereafter, a load parameter {(P−Pᵤ)/C}·1/aₒ is calculated. On the basis of the lubrication parameter and the load parameter {(P−Pᵤ/C}·1/aₒ, a life correction coefficient a_{NSK} is calculated with reference to a life correction coefficient calculation map. The bearing life L_{A} is calculated as L_{A}=a_{I}·a_{NSK}·(C/P)^{P}.

In all of the models described above, the calculated life of a bearing is a number that is given on the basis of a statistical test; the life is not an absolute repeatable quantity. Since the testing method provides a statistics-based life number, any calculation based thereon will always be inherently statistical as well. Consequently, there is a need for a model that treats a bearing failure not as a random event, but as an actual event that occurs as the final stage of a cumulative fatigue damage process.

### SUMMARY

The present invention concerns a method of determining the life and/or the remaining life of a hardened metal object that is subjected to fatigue conditions, where the method is based on the measurement of changes in the microstructure of the hardened metal and relating this measurement to a known decrease in material strength that leads to material failure. The method is further based on a combination of knowledge of material deterioration and an appropriate measurement of actual material condition.

According to a first aspect, the present invention defines a method of indicating the rate of microstructural deterioration of a hardened metal object in relation to the rate of plastic shear strain (fatigue damage rate), and calculating therefrom the evolution of microstructural deterioration as a function of fatigue exposure time or number of load cycles.

According to a second aspect, the present invention defines a method of calculating the evolution of Fatigue Damage Index (FDI) of the hardened metal object as a function of fatigue exposure time or number of load cycles.

According to a third aspect, the present invention defines a method of determining the consumed life of the hardened metal object based on measurement of an actual value of the FDI.

According to a fourth aspect, the present invention defines a method of calculating the expected life and/or remaining life of the hardened metal object based on a known critical value of FDI that leads to material failure.

According to a further aspect, the present invention relates to a computer program product implementing at least one of the previous aspects.

According to a still further aspect, the present invention relates to a computer readable medium containing program instructions according to any of the previous aspects.

The present invention has its basis in a metal physics description of how hardened metal materials behave under high cycle fatigue conditions, including not only the effects of the Hertzian contact stress field, but also the effects of the operating temperature, superimposed (hoop and residual) stresses and speed. The term fatigue includes at least one of rolling contact fatigue (RCF) and structural fatigue, such as rotating bending fatigue, torsion fatigue, uniaxial fatigue, including push-pull fatigue, and multiaxial fatigue. In the proposed model, fatigue damage is seen as a cumulative small-scale plastic deformation process, being controlled by a thermally activated dislocation climb process. The damage induced is a result of a secondary creep-like dislocation process, where iron self-diffusion controlled climb constitutes the rate controlling step, while the major part of the damage induced is a result of dislocation glide, once the dislocations are freed from the obstacles via the climb process (climb and glide). The damage process is therefore driven by the applied shear stress field and is rate controlled via diffusion-controlled climb.

The present invention also makes use of techniques by which microstructural changes in a hardened metal can be measured. A commonly used indicator of the condition of a material is the Full Width at Half Maximum (FWHM), obtained from X-ray diffraction measurements. The FWHM is a measure of the line width of a specific and suitably selected diffraction peak. For bearing steels, the 211-diffraction peak of chromium K-alpha radiation is advantageous. Although X-ray diffraction is a preferred method of quantifying microstructural deterioration, the invention is not restricted to this technique, but includes any technique that is capable of measuring microstructural changes at a sufficiently small scale.

In hardened metals, the original value (prior to fatigue exposure) for the FWHM is relatively large and decreases over the lifetime when the hardened metal experiences fatigue loading. A relative measure of the material condition can therefore be obtained by dividing the actual measured FWHM value by the original FWHM value. This ratio is commonly known as the Fatigue Damage Index (FDI). The FDI provides a quantitative snapshot of the state of microstructural deterioration in a hardened metal object, but it cannot be used to predict remaining life as, thus far, there has been no means of quantifying the evolution of microstructural deterioration as the hardened metal object continues to experience fatigue loading.

Thus, the present invention provides a method of determining the evolution of microstructural deterioration, which is based on an improved understanding that a direct relation exists between the plastic shear strain rate (rate of fatigue damage) and the rate at which the microstructure of the hardened metal object deteriorates. According to the invention, the plastic shear strain rate (fatigue damage rate) is calculated on the basis of an effective activation energy parameter for the dislocation climb process, shear stress amplitude, temperature and fatigue exposure time. The method of determining the rate of microstructural deterioration uses a differential equation that is based on a measurable parameter indicative of the microstructural condition of the hardened metal. The rate of change in the measurable parameter is representative of the rate of microstructural deterioration. When the measurable parameter is FWHM, the differential equation for the rate of microstructural deterioration may be formulated as follows:

$$\frac{d b}{b - {b}_{th}} = - {C}_{t} {〈 \frac{{τ}_{xz} ( t ) - {τ}_{u}}{G} 〉}^{c} \cdot {e}^{- \frac{{Q}_{0} - Δ V \cdot {σ}_{hyd} ( t )}{RT ( t )}} d t \qquad ( equation A )$$

wherein
b is a value of FWHM (degrees) which varies in the range b_{sd}→b, where b_{sd} is the FWHM after a shakedown phase
bₜₕ is the minimum FWHM (degrees) that will be approached when t→∞
Cₜ is a proportionality constant (s⁻¹)
τ_{xz} is the shear stress at the point of interest (Pa)
τᵤ is the fatigue limit of the hardened metal (Pa)
t is fatigue exposure time (s)
G is the shear stress modulus (Pa)
c is the shear stress exponent (−)
Q₀ is the activation energy for the diffusion controlled micro-plastic strain mechanism in the absence of internal stress (J/mol)
ΔV is the activation volume (m³/mol)
σ_{hyd} is the hydrostatic pressure (Pa)
R is the universal gas constant (J/mol·K)
T is the absolute temperature at the point of interest (K)

The arrow bracket in equation A returns a zero value for a negative argument and otherwise returns the calculable value. Equation A allows varying operating conditions and can be (numerically) integrated over time, where t varies in the range 0→t, while b varies in the range b_{sd}→b.

A special solution of this equation is obtained by integration for constant fatigue operating conditions over time, which leads to the following equation for the evolution of microstructural deterioration:

$$b ( t ) = {b}_{th} + ( {b}_{sd} - {b}_{th} ) \cdot {e}^{- C ( t )} \\ where \\ C ( t ) = {C}_{t} {〈 \frac{{τ}_{xz} - {τ}_{u}}{G} 〉}^{c} \cdot {e}^{- \frac{{Q}_{0} - Δ V \cdot {σ}_{hyd}}{RT}} \cdot t \qquad ( equation B )$$

and, once again, the arrow bracket returns a zero value for a negative argument and otherwise returns the calculable value.

The above equations may be reformulated on the basis of fatigue load cycles, N, via the relation between cycles and time:

$$t ∼ \frac{N}{f} and d t ∼ \frac{1}{f} d N ,$$

where

f is the load cycle frequency (Hz) or rotational speed in the case of a rolling element bearing, to obtain:

$$\frac{d b}{b - {b}_{th}} = - {C}_{N} {〈 \frac{{τ}_{xz} ( N ) - {τ}_{u}}{G} 〉}^{c} \cdot {e}^{- \frac{\begin{matrix}{Q}_{0} - Δ V \cdot \\ {σ}_{hyd} ( N )\end{matrix}}{RT ( N )}} \cdot \frac{1}{f ( N )} d N \qquad ( equation C )$$

where C_{N} is a proportionality constant (s⁻¹) and, once again, the arrow bracket returns a zero value for a negative argument and otherwise returns the calculable value;
and for constant fatigue operating conditions

$$b ( N ) = {b}_{th} + ( {b}_{sd} - {b}_{th} ) \cdot {e}^{- D ( N )} \\ where \\ D ( N ) = {C}_{N} {〈 \frac{{τ}_{xz} - {τ}_{u}}{G} 〉}^{c} \cdot {e}^{- \frac{{Q}_{0} - Δ V \cdot {σ}_{hyd}}{RT}} \cdot \frac{N}{f} \qquad ( equation D )$$

and, once again, the arrow bracket returns a zero value for a negative argument and otherwise returns the calculable value.

According to a second aspect of the invention, an expression for the evolution of Fatigue Damage Index as a function of fatigue exposure time is obtained by dividing the equation for the evolution of microstructural deterioration by the original value of the measurable parameter of microstructural deterioration, i.e. the value measured before the hardened metal object was exposed to fatigue. When the measurable parameter is FWHM and in the case where the fatigue loading conditions are constant, the evolution of FDI may be formulated as:

$$FDI ( t ) = \frac{{b}_{th} + ( {b}_{sa} - {b}_{th} ) \cdot {e}^{- C ( t )}}{B} \qquad ( equation E )$$

wherein
B is the original Full Width at Half Maximum value (degrees) of the hardened metal object
   or, in load cycles,

$$FDI ( N ) = \frac{{b}_{th} + ( {b}_{sd} - {b}_{th} ) \cdot {e}^{- D ( N )}}{B} \qquad ( equation F )$$

The above equations are a means of calculating the FDI as a function of fatigue exposure time or number of load cycles, where the input parameters are the operating conditions, known material constants and measurable quantities. Shakedown, induced by either classic yielding (dislocation glide) or by a primary creep-like deformation process (dislocation climb+glide) is plastic damage that occurs during the early part of the fatigue process (typically less than one percent of the fatigue life). The FWHM value after shakedown (b_{sd}) can be measured for a given material with a specific heat treatment. It has been found that in hardened materials, the FWHM value decreases over fatigue exposure time and then asymptotically approaches a threshold value. This value (bₜₕ) can also be measured for a given material and heat treatment, as can the original FHWM value (B).

Consequently, if a critical FDI is known, the critical FDI being, for example, the FDI value at which 10% of a tested population failed, the projected L10 life of a hardened metal object can be obtained from the expression for FDI(N) using a graphical or mathematical approach. In the case of rolling element bearings, the critical FDI is obtained from bearing life tests. Extensive testing has been performed under various operating conditions and the critical Fatigue Damage Index has been determined for various bearings. It has been found that the critical FDI value remains essentially constant for a given material and heat treatment and a given set of operating conditions. In the course of the life tests, FWHM measurements were taken at defined intervals, in order to obtain measurement data on the evolution of FWHM as function of number of fatigue load cycles, at a variety of loading conditions. This measurement data then provides the basis for calibrating the above equations, so that the projected L10 life is then the number of fatigue load cycles corresponding to the critical FDI.

Taking equation F and a rolling element bearing exposed to rolling contact fatigue as an example, the projected L10 life of a certain bearing operated under a known set of conditions is obtained according to the invention by fitting the solution of the equation through one or more known data points for the bearing steel and heat treatment in question. Preferably, the known data points are for a bearing of the same type and, more preferably, for a bearing of the same type operated under the same conditions as the known operating conditions.

As described, the number of fatigue load cycles corresponding to the critical FDI, N_{critical FDI}, can be obtained by means equation F for FDI(N). Hence, the remaining life of a hardened metal object, N_{RL}, can be calculated by subtracting the actual number of fatigue load cycles, N_{actual}:

N_{RL}=N_{critical FDI}−N_{actual} (equation G)

The actual number of fatigue load cycles, N_{actual}, which a hardened metal object has undergone can also be determined by means of equation F, by first measuring the actual FWHM value and dividing this by the original FWHM value. The original value may be a known value for the hardened metal concerned, or may be obtained by measuring the FWHM value in an unloaded region of the metal object. The result of the calculation is the actual Failure Damage Index, FDI_{actual}, and N_{actual} is then the number of fatigue load cycles that corresponds to FDI_{actual}. If the actual number of fatigue load cycles is known, the equation for FDI(N) is fitted through the actual FDI value, to improve the accuracy of the determination of N_{critical FDI}.

In this way the remaining life of a hardened metal object can be calculated.

In an advantageous further development, the result of the life calculation and remaining life calculation may be expressed with an upper and lower confidence limit. The upper and lower limits may be obtained from a statistical interpretation of life test data for bearings made from a given hardened metal, heat-treated in a given manner. The advantage of this development is improved predicting power and design safety.

According to a further aspect, a computer program product is disclosed. It is loadable into the internal memory of a computer, comprising software code portions for performing step(s) of any of the previous aspects, when run on the computer.

According to still a further aspect, a computer readable medium containing program instructions for execution on a computer system, which when executed by the computer system, cause the computer system to perform step(s) of any of the previous aspects.

A number of aspects/embodiments of the invention have been described. It is to be understood that each aspect/embodiment may be combined with any other aspect/embodiment, unless clearly indicated to the contrary.

### BRIEF DESCRIPTION OF THE DRAWINGS

The invention will now be described in more detail for explanatory, and in no sense limiting, purposes, with reference to the following figures, in which

FIG. 1 shows an example of FWHM values obtained for an unused bearing and for a fatigue-loaded bearing,

FIG. 2 shows a graph of calculated microstructural deterioration over time as a function of fatigue load cycles,

FIG. 3 shows an example of calibration curves for microstructural deterioration as a function of fatigue exposure time,

FIG. 4 shows a graph of Fatigue Damage Index as a function of fatigue load cycles,

FIG. 5 shows a flowchart of a method according to the invention,

FIG. 6 shows a schematic illustration of a device suitable for executing the methods according to the present invention.

### DETAILED DESCRIPTION

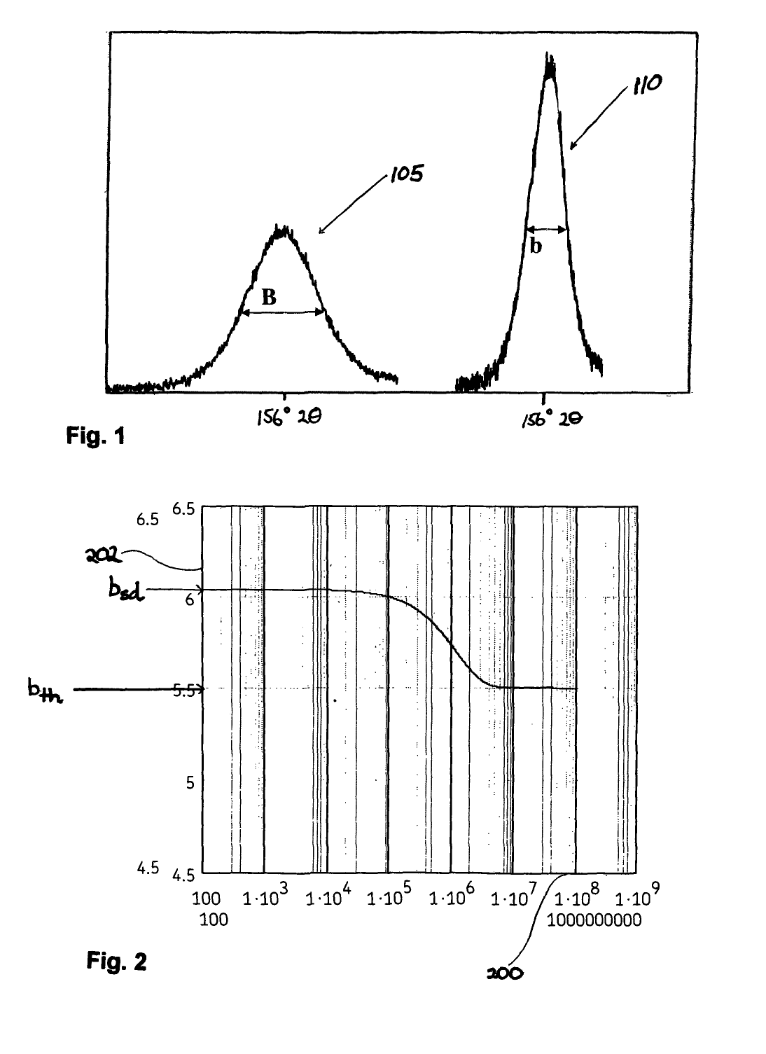

In order to clarify the method and device according to the invention, some examples of its use will now be described in connection with FIGS. 1 to 6. Furthermore, the inventive method will be described with particular reference to a rolling element bearing made of bearing steel that is subjected to rolling contact fatigue. It is to be understood, however, that the methods according the invention may be applied with regard to any type of hardened metal object that is subjected to any type of cyclical fatigue loading.

A fundamental aspect of the invention is the understanding that during fatigue, the microstructure of materials experiences continuous changes until failure.

According to the invention, fatigue damage is seen as a cumulative small-scale plastic deformation process, being controlled by a thermally activated dislocation climb process. The damage induced is a result of a secondary creep-like dislocation process, where iron self-diffusion controlled climb constitutes the rate controlling step, while the major part of the damage induced is a result of dislocation glide, once the dislocations are freed from the obstacles via the climb process (climb and glide). The damage process is therefore driven by the applied shear stress field and is rate controlled via diffusion-controlled climb.

The present invention is based on a metal physics description of the behaviour of hardened (martensite or bainite) steels. Hardened steels can, from a metal physics point of view, be characterised as being non-equilibrium steels (at equilibrium all steels are soft). Hardened steels behave differently from softer steels under fatigue loading. Since fatigue is a result of accumulated damage, induced by incremental micro-plastic deformation in each load cycle, the key to improved predictability lies in understanding the micro-plastic behaviour of hard steels.

While plastic deformation in softer steels is controlled by one deformation mechanism: dislocation glide or micro-yielding; plastic deformation in hard steels, in their non-equilibrium state, may be induced by two different mechanisms: dislocation glide and dislocation climb. The first deformation mechanism, dislocation glide, is only active above a given threshold stress level (the micro-yield limit), while dislocation climb, although strongly stress dependent, is active at all stress levels, not excluding the existence of a lower threshold stress level below which the climb mechanism does not occur. The dislocation climb mechanism is governed by diffusion processes. The fatigue response, therefore, also becomes strongly influenced by temperature, time and internal (hoop and residual) stresses and will therefore also be influenced by the frequency of the fatigue load cycles.

Fatigue exposed components made of hardened and low-temperature tempered steels typically fail due to crack initiation from various defects. With respect to rolling contact fatigue, these defects are present either at the raceway surface (indentations from handling damage or mounting, denting from contaminated running or surface damage induced from improper lubrication, etc.) or within the material, i.e. subsurface defects like non-metallic inclusions, pores, pre-existing cracks, etc. Defects like these act as local stress raisers leading to a locally accelerated fatigue damage. The shear stress driven and thermally activated fatigue damage processes discussed in this document occur at a higher rate in the steel matrix adjacent to the defects. The result is that the material, at some point in time, will fail locally at these highly stressed points, leading to crack initiation. From this point in time, the fatigue damage process will change to become one of crack propagation till failure (spalling).

The actual condition of a material surface or subsurface is therefore an important factor in the fatigue life of the material. Consequently, a further fundamental aspect of the invention is to quantify the material condition in terms of microstructural deterioration and combine this with the improved understanding of fatigue. The result is an improved method of determining the life and/or remaining life of e.g. a bearing, where the method is based on the measurement of changes in the microstructure of the bearing steel and relating this measurement to a known level of microstructural deterioration that leads to material failure.

According to the invention, a method is provided for indicating the evolution of microstructural deterioration as a function of fatigue exposure time, based on the understanding that a direct relation exists between the plastic shear strain rate and the rate at which the microstructure deteriorates.

A preferred method of expressing microstructural deterioration is in terms of the line width of a specific diffraction peak on an X-ray diffractogram. The 211-diffraction peak of CrKα_{1,2} radiation has been found to be advantageous for bearing steel and for measuring its microstructural condition, but other diffraction peaks may be used. Needless to say, the same diffraction peak should be used consistently. The line width is generally expressed as Full Width at Half Maximum, which is abbreviated to FWHM. Among the factors which contribute to FWHM are material condition factors. It has been found that in hardened metals, the FWHM decreases as the number of microstructural defects increases as a result of accumulated plastic strain damage.

An example of the decrease in FWHM can be seen in FIG. 1, which shows peaks 105 and 110 from X-ray diffraction measurements performed on a bearing prior to fatigue exposure 105 and after the bearing had been exposed to fatigue 110. Clearly, the FWHM value B of the unused bearing is greater than the FWHM value b of the fatigue-exposed bearing. The bearing used in the measurements was made from SAE52100 bearing steel (DIN 100Cr6) and the X-ray diffraction measurement was performed using CrKα_{1,2} radiation and the 211-diffraction peak at approximately 156 degrees 2-theta.

One embodiment of the present invention provides a method of indicating the evolution of microstructural deterioration as a function of fatigue exposure time, where the microstructural deterioration is expressed in terms of FWHM. The method is based on a relationship between the rate of change in FWHM and the fatigue damage rate, where the rate of change in FWHM is representative of the rate of microstructural deterioration. The rate of change in another, suitable, measurable parameter indicative of microstructural condition could also be used. The fatigue damage rate is calculated on the basis of an effective activation energy parameter for the dislocation climb process, shear stress amplitude, absolute local temperature and fatigue exposure time. According to the invention, the relationship between the rate of microstructural deterioration and the fatigue damage rate may be expressed by means of the following differential equation:

$$\frac{db}{b - {b}_{th}} = - {C}_{t} {〈 \frac{{τ}_{xz} ( t ) - {τ}_{u}}{G} 〉}^{c} \cdot {e}^{- \frac{{Q}_{0} - Δ V \cdot {σ}_{hyd} ( t )}{RT ( t )}} dt \qquad ( equation 1 )$$

wherein
b is a value of FWHM (degrees) which varies in the range b_{sd}→b, where b_{sd} is the FWHM after a shakedown phase, measured at a depth z
bₜₕ is the minimum FWHM (degrees), measured at the depth z, that will be approached when t→∞
Cₜ is a proportionality constant (s⁻¹)
τ_{xz} is the shear stress at the depth z (Pa)
τᵤ is the fatigue limit of the hardened metal (Pa)
t is fatigue exposure time (s)
G is the shear stress modulus (Pa)
c is the shear stress exponent (−)
Q₀ is the activation energy for the diffusion controlled micro-plastic strain mechanism in the absence of internal stress (J/mol)
ΔV is the activation volume (m³/mol)
σ_{hyd} is the hydrostatic pressure (Pa)
R is the universal gas constant (J/mol·K)
T is the absolute temperature (K) at the depth z.

The arrow bracket returns a zero value for a negative argument and otherwise returns the calculable value. Equation 1 allows varying operating conditions and can be (numerically) integrated over time, where t varies in the range 0→t, while b varies in the range b_{sd}→b.

A special solution of this equation is obtained by integration for constant fatigue loading conditions over time, which leads to the following expression for the evolution of microstructural deterioration:

$$b ( N ) = {b}_{th} + ( {b}_{sd} - {b}_{th} ) \cdot {e}^{- C ( t )} \\ where \\ C ( t ) = {C}_{t} {〈 \frac{{τ}_{xz} - {τ}_{u}}{G} 〉}^{c} \cdot {e}^{- \frac{{Q}_{0} - Δ V \cdot {σ}_{hyd}}{RT}} \cdot t \qquad ( equation 2 )$$

The above equations may be reformulated on the basis of load cycles, N, via the relation between cycles and time:

$$t \sim \frac{N}{f} and dt \sim \frac{1}{f} dN ,$$

where

f is the load cycle frequency (Hz), or rotational speed in the case of a rolling element bearing, to obtain:

$$\frac{db}{b - {b}_{th}} = - {C}_{N} {〈 \frac{{τ}_{xz} ( N ) - {τ}_{u}}{G} 〉}^{c} \cdot {e}^{- \frac{{Q}_{0} - Δ V \cdot {σ}_{hyd} ( N )}{RT ( N )}} \cdot \frac{1}{f ( N )} dN \qquad ( equation 3 )$$

where C_{N} is a proportionality constant (s⁻¹),
and for constant fatigue operating conditions

$$b ( N ) = {b}_{th} + ( {b}_{sd} - {b}_{th} ) \cdot {e}^{- D ( N )} \\ where \\ D ( N ) = {C}_{N} {〈 \frac{{τ}_{xz} - {τ}_{u}}{G} 〉}^{c} \cdot {e}^{- \frac{{Q}_{0} - Δ V \cdot {σ}_{hyd}}{RT}} \cdot \frac{N}{f} \qquad ( equation 4 )$$

A typical curve of the b(N) function is shown in FIG. 2, where the x-axis 200 represents fatigue exposure in load cycles and the y-axis 202 represents FWHM in degrees. The curve starts at the value after shakedown b_{sd}, decreases and then asymptomatically approaches its lowest threshold value bₜₕ. The evolution rate of b is proportional to fatigue damage rate, but has a threshold value below which no further change occurs.

Thus, equation 4 represents an expression for the evolution of microstructural deterioration of e.g. a bearing component that is subjected to rolling contact fatigue, where the input parameters are measurable quantities (b_{sd} and bₜₕ), natural constants (R) or material constants (G, τᵤ, Q₀ and ΔV) and the operating conditions of the bearing (τ_{xz}, σ_{hyd}, T and f (bearing speed)).

With regard to a bearing subjected to rolling contact fatigue, the shear stress, τ, may be calculated on the basis of the applied load and the geometry of the contact. The hydrostatic pressure, σ_{hyd}, may be calculated on the basis of the applied load and the geometry of the contact, the hoop stress and any residual stress. The temperature and speed can likewise be measured.

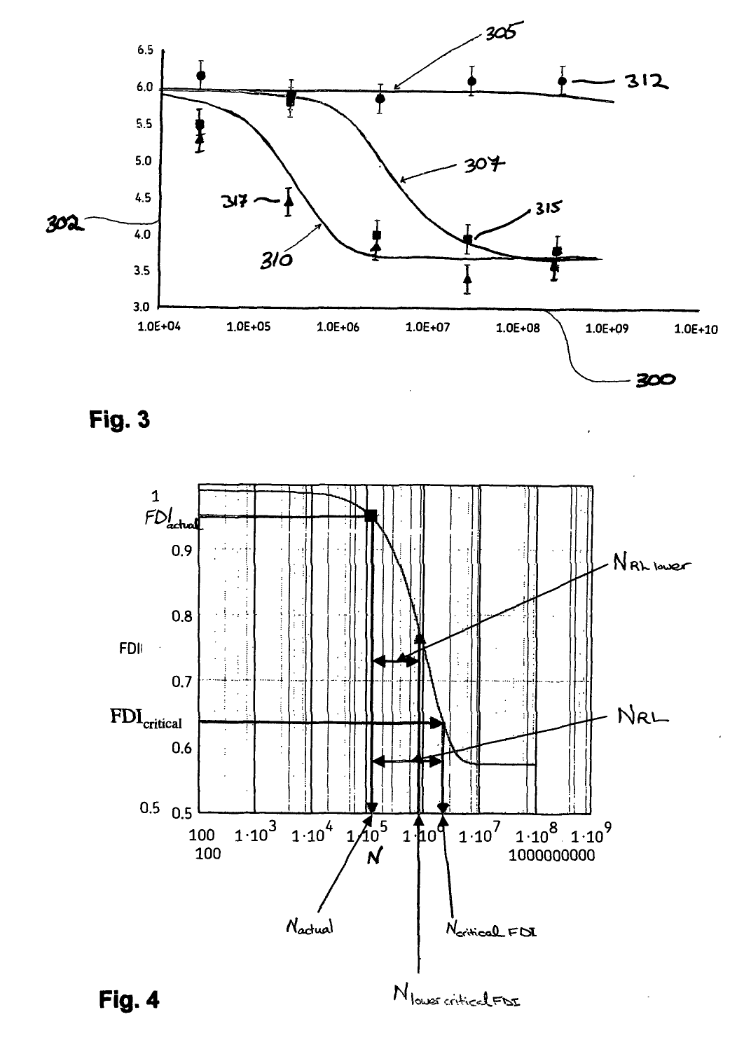

The proportionality constants Cₜ and C_{N}, respectively, are found by fitting the equations to experimental calibration test data. A graph of the data obtained from such a calibration test is shown in FIG. 3, where the x-axis 300 represents number of fatigue load cycles and the y-axis 302 represents FWHM. The calibration test here is relevant for a bearing steel subjected to rolling contact fatigue. Three bearing sets from one bearing steel and heat treatment were operated under three different conditions. At predefined intervals, X-ray diffraction measurements were performed to obtain FWHM values corresponding to known numbers of load cycles. The three curves shown 305, 307 and 310 were obtained from the measured data points 312, 315 and 317, which data points are shown on the graph with their confidence levels. The three sets of data points 312, 315 and 317 correspond to three sets of operating condition at predetermined values of operating temperature, contact pressure and hoop stress.

According to a further aspect of the invention, a method of determining the evolution of a Fatigue Damage Index as a function of fatigue exposure time, FDI(t), is provided. The method is based on the following equation:

$$FDI ( t ) = \frac{b ( t )}{B} \qquad ( equation 5 )$$

where
b(t) is obtained according to equation 2, and
B is the original FWHM value (degrees) of the hardened metal object, measured at the depth z.

The evolution of FDI may also be expressed in load cycles, N:

$$FDI ( N ) = \frac{b ( N )}{B} \qquad ( equation 6 )$$

where
b(N) is obtained according to equation 4.

It should be noted here that measurements of FWHM should be performed at the same depth. The measurement depth, z, depends on the mode of failure that is expected. If surface failure is expected, for example in starved lubrication conditions or in a large-size bearing where the rolling elements are subject to extensive slip, the FWHM measurement depth should be zero. If subsurface failure is expected, the depth at which maximum shear stress occurs may be used. Alternatively, a depth profile could be constructed, where consecutive measurements are performed after consecutive material removal steps. An integration value of FWHM over the full depth profile could then be used. Whatever measurement depth or depth profile is used, the most important consideration is that the same depth or depth profile is used consistently throughout the evaluation process. It should also be noted that when FWHM measurements are performed to determine material deterioration, they should be performed in a region of the mechanical object that has been exposed to maximum fatigue loading. In a rolling element bearing, this region might be the outer raceway surface in the loaded zone of the bearing, but the actual region depends on the application.

The Fatigue Damage Index is a measure of the condition of a material relative to its original condition. For any material, there is a critical value of the Index, FDI_{critical}, at which failure is imminent. With regard to rolling element bearings, life tests are performed on a population of bearings under predefined operating conditions. From these tests, an L10 life is derived, which is the time or number of load cycles after which 10 percent of the tested population has failed. Bearing failure is deemed to have occurred when the measured vibration exceeds a predefined limit. From such L10 life tests, and from X-ray diffraction measurements of the failed bearings, it has been found that in surface failure mode, FDI_{critical} for bearing steel is approximately equal to 0.86. One example of a value for FDI_{cntical} in subsurface failure mode is 0.64. The value of FDI_{critical} also depends on the material and heat treatment, the type of bearing, and, to some extent, on the operating conditions. However, an average value of FDI_{critical} for a particular material and heat treatment is a useful approximation.

According to the invention, the value of FDI_{critical} may be used to determine the expected life of a bearing or other hardened metal object that is exposed to fatigue.

FIG. 4 shows an example of a graph of FDI(N), obtained by means of equation 6 for a certain bearing operated under a given set of operating conditions. The x-axis represents fatigue exposure time in number of load cycles and the y-axis represents the Fatigue Damage Index. The curve is fitted through one or more experimentally determined data points. Preferably, these data points are known data points for the bearing in question, operated under the given set of operating conditions. Using the example for subsurface failure, where FDI_{critical}=0.64 (obtained from L10 life tests), it can be seen from FIG. 4 that the projected L10 life of the bearing, N_{L10}, may be obtained from the number of load cycles that corresponds to FDI_{critical}. In other words, N_{L10}=N_{critical FDI}.

Thus, according to the invention, a method of determining the expected fatigue life of a hardened metal object is provided. In the above example, an L10 life was calculated, as this is the standard way of expressing bearing life. It will be clear, however, that the method may be adapted to determine life according to a different standard.

It is also standard practice in the field of bearing life tests to quote an upper and a lower confidence limit. These limits are obtained from L10 life test data; for example, by means of a statistical interpretation of a set of possible combinations. Thus, an L10 life test results in a certain bearing life (number of fatigue load cycles), N_{Life test}, which has a certain upper confidence limit, Nᵤₚₚₑᵣ, and a certain lower confidence limit, N_{lower}. The same principle may be applied to the method of the invention in order to obtain a lower confidence limit for the number of fatigue load cycles corresponding to the critical Fatigue Damage Index, N_{lower critical FDI}, and an upper confidence limit for the number of fatigue load cycles corresponding to the critical Fatigue Damage Index, N_{upper critical FDI}. The lower confidence limit is obtained according to

N_{lower critical FDI}=(N_{lower}/N_{Life test})·N_{critical FDI} (equation 7)

The upper confidence limit is obtained according to

N_{upper critical FDI}=(Nᵤₚₚₑᵣ/N_{Life test})·N_{critical FDI} (equation 8)

According to a further aspect of the invention, a method of calculating the remaining life of a hardened metal object is provided.

As described previously, the fatigue life of a hardened metal object may be obtained from equation 6 in combination with a known critical value of material deterioration that leads to failure, where fatigue life=N_{critical FDI}. Remaining life, expressed as a number of fatigue load cycles, N_{RL}, can therefore be calculated by subtracting an actual number of fatigue load cycles, N_{actual}, i.e.

N_{RL}=N_{criticalFDI}−N_{actual} (equation 9)

The actual number of fatigue load cycles that an object has experienced may also be obtained from equation 6, by determining an actual Fatigue Damage Index, FDI_{actual}. As described previously, this value may be obtained by measuring the FWHM in a region that has undergone maximal fatigue loading and dividing the result of the measurement by the original FWHM value. The original FWHM value may be a known value for the hardened metal and heat treatment concerned, or it may be obtained by measuring the FWHM in a region of the object that was not subjected to fatigue loading. Again with reference to FIG. 4, it may be seen that the actual number of fatigue load cycles N_{actual} is the number that corresponds to FDI_{actual}. If the actual number of fatigue load cycles is known, this value together with the measured value for FDI_{actual} is used as a known data point through which the equation for FDI(N) is fitted.

The remaining life N_{RL} is then calculated according to equation 9.

The remaining life N_{RL} may also be expressed in terms of a lower and an upper confidence limit, N_{RL lower} and N_{RL upper}, by utilizing the lower and upper confidence limits calculated in equations 7 and 8 respectively. Thus,

N_{RL lower}=N_{lower criticalFDI}−N_{actual} (equation 10)

and

N_{RL upper}=N_{upper criticalFDI}−N_{actual} (equation 11)

The result of a remaining life calculation according to equation 10, N_{RL lower}, is also shown in the graph of FIG. 4.

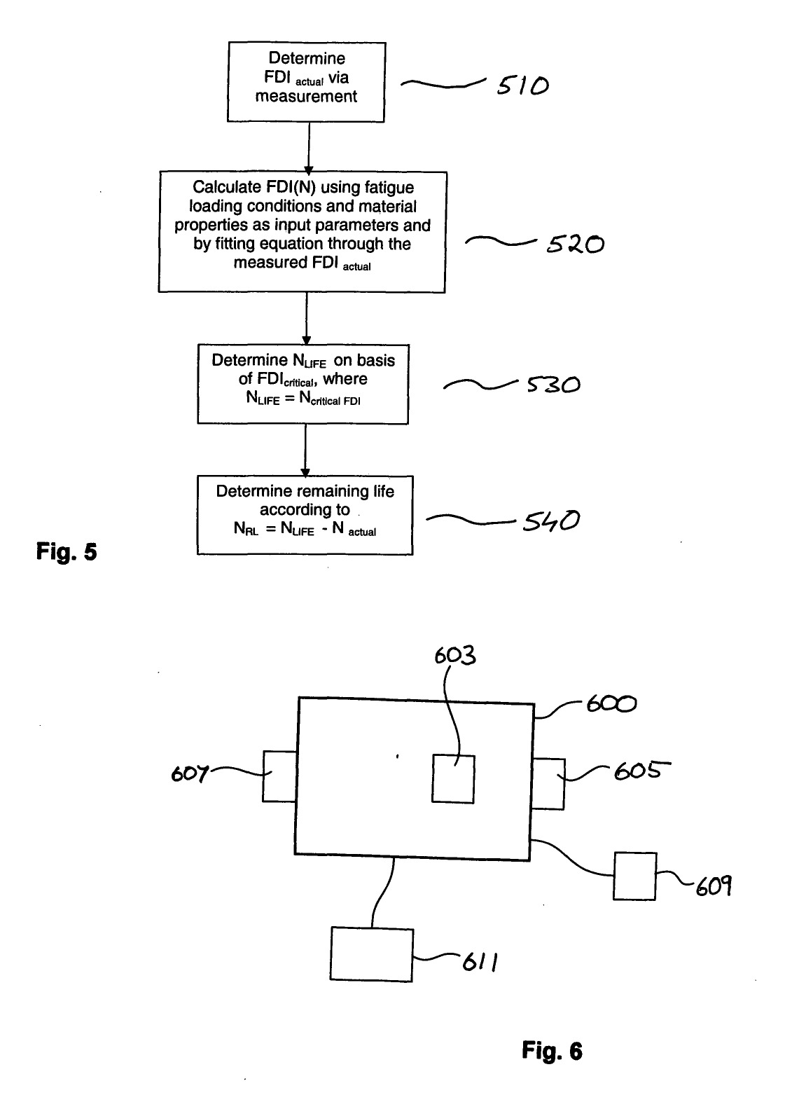

In the case of a hardened metal object that has been exposed to a number of fatigue loads cycles, N_{actual}, a preferred method according to invention of determining the expected life, N_{LIFE}, and remaining life, N_{RL}, in relation to fatigue load cycles, is shown schematically in the flowchart of FIG. 5.

In a first step 510, the actual Failure Damage Index, FDI_{actual}, of the metal object is established by measuring a parameter indicative of the actual microstructural condition of the metal object and dividing this measured parameter by an original parameter value, where the original parameter value is indicative of the microstructural condition of the metal object prior to fatigue exposure.

In a second step 520, the evolution of FDI as a function of fatigue load cycles is calculated, where the input parameters for the corresponding equation are the fatigue loading conditions and material properties of the hardened metal object and where the equation is fitted through the value of FDI_{actual} obtained in the first step.

In a third step 530, the expected life of the hardened metal object in relation to a number of fatigue load cycles, N_{LIFE}, is determined by means of a known critical value of FDI that leads to material failure, FDI_{critical} where N_{LIFE} is obtained from the number of fatigue load cycles that corresponds to FDI_{critical}.

In a fourth step 540, the remaining life of the hardened metal object is determined by subtracting the actual number of fatigue load cycles exerted on the hardened metal object, N_{actual}, from N_{LIFE}.

In FIG. 6 a device 600 suitable for executing the methods according to the present invention is given. It comprises a processor 603 for executing the methods, and input/output means 605, such as a mouse or a keyboard. In one embodiment, it comprises data communication capabilities 607 for receiving and transmitting metal object data and possibly results. It may also comprise a screen 609 and/or another output device such as a printer 611 for outputting results from the execution of the methods according to the present invention.

According to the invention, by introducing a better material description, further improved predictability power of models can be achieved. Such improved models can be used to better dimension metal objects, e.g. bearings, for adverse operating conditions like environmental influences or combined high load and temperature leading to marginal lubrication conditions. By including additional influencing operating parameters like temperature, internal stress state and fatigue exposure time, improved predictability of e.g. life of mechanical objects is provided.

The methods of the invention have been described with regard to quantification of microstructural deterioration by means of X-ray diffraction measurements performed using a specific radiation and diffraction peak which are suitable for bearing steel and measuring microstructural changes therein. It should be understood that other diffraction peaks and other types of X-ray diffraction measurements could be used; for example, measurement of residual stresses or phase composition (retained austenite is the most important second phase in hardened bearing steel). Moreover, the method of the invention is not restricted to X-ray diffraction measurements. It will be clear to those skilled in the art that by changing the constants in the equations, the inventive method may be adapted for any technique that is capable of measuring microstructural changes at a sufficiently small scale. Examples of such techniques are electro-magnetic methods (electrical resistance, Barkhausen noise, etc), acoustic methods and sub-atomic methods (neutron diffraction, positron annihilation, etc.).

In short, the invention is not restricted to the aspects and/or embodiments described, but may be varied within the scope of the accompanying patent claims.

1. A method of indicating an evolution of microstructural deterioration of a hardened metal object in relation to fatigue load cycles, N, exerted on the hardened metal object, the method comprising the step of determining the evolution of microstructural deterioration by means of a relationship between a rate of change in a measurable parameter indicative of microstructural condition of the hardened metal object and a fatigue damage rate of the hardened metal object, where the fatigue damage rate is calculated on the basis of an effective activation energy parameter for the dislocation climb process, Q₀, shear stress amplitude, τ_{xz}, the absolute local temperature of the hardened metal object, T, and load frequency, f.

2. The method according to claim 1, wherein the measurable parameter indicative of the microstructural condition of the hardened metal object is a Full Width at Half Maximum, FWHM, obtainable from a diffraction peak of an X-ray diffraction measurement.

3. The method according to claim 1, wherein the relationship between the rate of change in the measurable parameter and the fatigue damage rate is expressed by the differential equation
$$\frac{db}{b - {b}_{th}} = - {C}_{N} {〈 \frac{{t}_{xz} ( N ) - {t}_{u}}{G} 〉}^{c} \times {e}^{- \frac{{Q}_{0} - DV \times {s}_{hyd} ( N )}{RT ( N )}} \times \frac{1}{f ( N )} dN$$
wherein
b is a value of FWHM (degrees) which varies in the range b_{sd}→b, where b_{sd} is the FWHM after a shakedown phase, measured at a depth z
bₜₕ is the minimum FWHM (degrees) that will be reached when N→∞, measured at the depth z
C_{N} is a proportionality constant (s⁻¹)
T_{xz} is the shear stress (Pa) at the depth z
τᵤ is the fatigue limit of the hardened metal (Pa)
N is the fatigue exposure in number of load cycles (−)
G is the shear stress modulus (Pa)
c is the shear stress exponent (−)
Q₀ is the activation energy for the diffusion controlled micro-plastic strain mechanism in the absence of internal stress (J/mol)
ΔV is the activation volume (m³/mol)
σ_{hyd} is the hydrostatic pressure (Pa)
R is the universal gas constant (J/mol·K)
T is the absolute temperature at the point of interest (K)
f is the frequency of the fatigue load cycles (Hz).

4. The method according to claim 3, further comprising a step of obtaining a solution to the differential equation by integrating the differential equation over fatigue exposure in load cycles.

5. The method according to claim 4, wherein the differential equation is integrated to obtain a solution for constant fatigue operating conditions.

6. The method according to claim 5, wherein the solution is an expression for the evolution of FWHM (b) as a function of load cycles, N, given by
$$b ( N ) = {b}_{th} + ( {b}_{sd} - {b}_{th} ) \cdot {e}^{- D ( N )}$$
$$where$$
$$D ( N ) = {C}_{N} {〈 \frac{{τ}_{xz} - {τ}_{u}}{G} 〉}^{c} \cdot {e}^{- \frac{{Q}_{0} - Δ V \cdot {σ}_{hyd}}{RT}} \cdot \frac{N}{f}$$

7. A method of indicating the evolution of a Fatigue Damage Index for a hardened metal object as a function of fatigue load cycles, N, comprising the steps of:
calculating a relationship between a rate of change in a measurable parameter and a fatigue damage rate by the differential equation
$$\frac{db}{b - {b}_{th}} = - {C}_{N} {〈 \frac{{t}_{xz} ( N ) - {t}_{u}}{G} 〉}^{c} \times {e}^{- \frac{{Q}_{0} - DV \times {s}_{hyd} ( N )}{RT ( N )}} \times \frac{1}{f ( N )} dN$$
wherein
b is a value of FWHM (degrees) which varies in the range b_{sd}→b, where b_{sd} is the FWHM after a shakedown phase, measured at a depth z
bₜₕ is the minimum FWHM (degrees) that will be reached when N→∞, measured at the depth z
C_{N} is a proportionality constant (s⁻¹)
T_{xz} is the shear stress (Pa) at the depth z
τᵤ is the fatigue limit of the hardened metal (Pa)
N is the fatigue exposure in number of load cycles (−)
G is the shear stress modulus (Pa)
c is the shear stress exponent (−)
Q₀ is the activation energy for the diffusion controlled micro-plastic strain mechanism in the absence of internal stress (J/mol)
ΔV is the activation volume (m³/mol)
σ_{hyd} is the hydrostatic pressure (Pa)
R is the universal gas constant (J/mol·K)
T is the absolute temperature at the point of interest (K)
f is the frequency of the fatigue load cycles (Hz); and
dividing the calculated relationship by an original value of the measurable parameter, indicative of the microstructural condition of the hardened metal object prior to fatigue exposure.

8. The method according to claim 7, wherein the step of calculating the evolution of Fatigue Damage Index, FDI, in relation to load cycles, N, is performed according to
$$FDI ( N ) = \frac{b ( N )}{B} ,$$
wherein
B is an original Full Width at Half Maximum value of the hardened metal object, at a depth z.

9. A method of determining the expected life of a hardened metal object in relation to a number of load cycles (N_{LIFE}) exerted on the hardened metal object, the method comprising the steps of:
measuring an actual value of Fatigue Damage Index for the hardened metal object;
calculating the evolution of Fatigue Damage Index by
calculating a relationship between a rate of change in a measurable parameter and a fatigue damage rate using the differential equation
$$\frac{db}{b - {b}_{th}} = - {C}_{N} {〈 \frac{{t}_{xz} ( N ) - {t}_{u}}{G} 〉}^{c} \times {e}^{- \frac{{Q}_{0} - DV \times {s}_{hyd} ( N )}{RT ( N )}} \times \frac{1}{f ( N )} dN$$
wherein
b is a value of FWHM de rees which varies in the range b_{sd}→b, where b_{sd} is the FWHM after a shakedown phase, measured at a depth z
bₜₕ is the minimum FWHM (degrees) that will be reached when N→∞, measured at the depth z
C_{N} is a proportionality constant (s⁻¹)
T_{xz} is the shear stress (Pa) at the depth z
τᵤ is the fatigue limit of the hardened metal (Pa)
N is the fatigue exposure in number of load cycles (−)
G is the shear stress modulus (Pa)
c is the shear stress exponent (−)
Q₀ is the activation energy for the diffusion controlled micro-plastic strain mechanism in the absence of internal stress (J/mol)
ΔV is the activation volume (m³/mol)
σ_{hyd} is the hydrostatic pressure (Pa)
R is the universal gas constant (J/mol·K)
T is the absolute temperature at the point of interest (K)
f is the frequency of the fatigue load cycles (Hz);
dividing the calculated relationship by an original value of the measurable parameter, indicative of the microstructural condition of the hardened metal object prior to fatigue exposure;
calibrating the calculated evolution on the basis of the measured value of Fatigue Damage Index; and
determining the expected life (N_{LIFE}) on the basis of a known critical value of Fatigue Damage Index that leads to material failure, where the number of fatigue load cycles corresponding to the critical value of the Fatigue Damage Index (N_{critical FDI}) equals the expected life.

10. The method according to claim 9, wherein the known critical value of Fatigue Damage Index is obtained from fatigue life tests performed on similar hardened metal objects made from the same hardened metal as the hardened metal object for which the expected life is determined.

11. The method according to claim 10, wherein the life tests are L10 life tests.

12. The method according to claim 10, wherein the number of fatigue load cycles corresponding to the critical value of the Fatigue Damage Index (N_{critical FDI}) is expressed in terms of at least one of an upper confidence limit and a lower confidence limit.

13. The method according to claim 9 further comprising the step of subtracting an actual number of fatigue load cycles (N_{actual}) from the expected life of the hardened metal (N_{LIFE}) so as to determine the remaining life of the hardened metal object in relation to the fatigue load cycles (N_{RL}) exerted on the hardened metal object.

14. The method according to claim 13, wherein the actual number of fatigue load cycles (N_{actual}) is obtained from a measurement of the actual Fatigue Damage Index (FDI_{actual}).

15-16. (canceled)
